(19) United States
(12) Patent Application Publication
(10) Pub. No.: US 2012/0295602 A1
(43) Pub. Date: Nov. 22, 2012

(54) METHOD AND APPARATUS FOR PROVIDING CALLED PARTY DATA TO A SUBSCRIBER OF A CALL FORWARDING SYSTEM VIA AT LEAST ONE MOBILE NETWORK

(75) Inventors: Saul Einbinder, Holmdel, NJ (US); David Ittner, Manalapan, NJ (US); Robert McCarthy, Marlborough, MA (US)

(73) Assignee: UREACH TECHNOLOGIES, INC., Holmdel, NJ (US)

(21) Appl. No.: 13/474,929

(22) Filed: May 18, 2012

Related U.S. Application Data
(60) Provisional application No. 61/487,819, filed on May 19, 2011.

(51) Int. Cl. H04W 4/16

(52) U.S. Cl. 455/417

(57) ABSTRACT

A method and apparatus for providing called party data to a subscriber of a call forwarding system via at least one mobile network. In one embodiment, the method includes processing an incoming call to a subscriber device of a call forwarding system, identifying a calling number and a called number of the incoming call, wherein the called number corresponds with a call forwarding number of the subscriber device, accessing called party data that is associated with the called number, and communicating the called party data to the subscriber device.

### CROSS-REFERENCE TO RELATED APPLICATIONS

This application claims priority to U.S. Provisional Patent Application Ser. No. 61/487,819, filed May 19, 2011, which is incorporated by reference herein in its entirety.

### BACKGROUND OF THE INVENTION

1. Field of the Invention

Embodiments of the present invention generally relate to communication systems and, in particular, to a method and apparatus for providing called party data to a subscriber of a call forwarding system via at least one mobile network.

2. Description of the Related Art

Call forwarding systems, which are also known as call diverting systems, are features on some telecommunication systems (i.e., telephone networks) that allow an incoming call to a called party, which would otherwise be unanswered, to be redirected to a mobile or smart phone having another telephone number (i.e., a call forwarding number) where the desired called party is actually located. For example, the subscriber may use a mobile phone as a personal phone and a landline phone as a business phone except for times when the subscriber is at another facility, and at those times, all business calls are forwarded to the mobile phone. As another example, the subscriber may use a single mobile phone for receiving business calls on one phone number and receiving personal calls on another phone number where the mobile phone is subscribed to two different mobile phone numbers.

Some call forwarding systems deliver additional information via audio data whispers. After the subscriber answers an incoming call and before the call forwarding system connects the calling party, the subscriber can listen to information about the incoming call and can accept or dispose of the incoming call by signaling via Dual-Tone Multi-Frequency (DTMF) back to the call forwarding system. This approach is used on commercial services (e.g., uReach.com, Google Voice) as well as on Private Branch Exchanges (PBXs) that forward to mobile or Public Switched Telephone Network (PSTN) phone numbers.

Current call forwarding systems are features of an automated answering service (e.g., virtual or auto attendant) or of a “find me/follow me” single number service. In these systems, a calling party calls a first number and navigates a set of menu options that are designed to direct the calling party to the appropriate called party. For example, the calling party may select a particular digit for a desired department (e.g., “press 1 for billing”, “press 2 for customer service”, “press 3 for technical support” and/or the like). In some cases, incoming calls are then routed to different individuals or groups based on the selection made by the calling party. In other systems, all incoming calls go to a single individual with the objective being to make the very small company seem larger to the calling party.

Unfortunately, important information, such as which auto-attendant selection or selections was made, is lost when the call is sent to a mobile phone that is also used for accepting personal calls. Some wire line, traditional call center-based systems can provide additional information to an answering party (e.g., employees of the subscriber or the subscribers themselves). Both the calling number/name and the called number/name can be displayed; however, these systems are primarily employed at large facilities, such as call centers or use hosted calling services with separate data terminals for delivery of supplemental information.

Therefore, there is need for a method and apparatus for providing called party data to a subscriber of a call forwarding system via at least one mobile network.

### SUMMARY OF THE INVENTION

Various embodiments of the present disclosure generally include a method and apparatus for providing called party data to a subscriber of a call forwarding system via at least one mobile network. In one embodiment, the method includes processing an incoming call to a subscriber device of a call forwarding system, identifying a calling number and a called number of the incoming call, wherein the called number corresponds with a call forwarding number of the subscriber device, accessing called party data that is associated with the called number and communicating the called party data to the subscriber device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a structural block diagram of a call forwarding system for providing called party data to a subscriber via at least one mobile network according to one or more embodiments;

FIG. 2 is a functional block diagram illustrating a process for providing called party data to a subscriber of a call forwarding system via a mobile data network according to one or more embodiments;

FIG. 3 is a flow diagram of a method for providing called party data to a subscriber of a call forwarding system via at least one mobile network according to one or more embodiments; and

FIG. 4 is a flow diagram of a method for handling an incoming call via at least one mobile network at a subscriber device of a call forwarding system according to one or more embodiments.

### DETAILED DESCRIPTION

Embodiments of the present invention comprise a method and apparatus for providing called party data to a subscriber of a call forwarding system via at least one mobile network. When a caller device calls a subscriber of a call forwarding system, the call forwarding system processes the call. The call forwarding system retrieves information regarding the subscriber and initiates a new call directed to the subscriber's mobile device. In doing so, information is provided to the subscriber device to assist the subscriber in deciding how to respond to the incoming call. When the caller initially called the subscriber, the caller may have navigated through a menu of options, each of which, for example, would direct the caller to a different department of a business (e.g., sales, technical support, and the like). The system may also have stored information regarding previous contact with the caller. The subscriber is presented with information about the caller, such as the caller's name, phone number, business, any stored notes regarding previous interactions with the caller, and the like. The subscriber is also presented with other information, such as which menu option the caller chose, allowing the subscriber to know, before responding to the caller, that the caller is seeking, for example, the sales department. Once the call with other information is received on the subscriber's mobile device, the subscriber may choose what action to take in response to the incoming call. The subscriber may choose to reject, answer, or ignore the call based on the other information. Alternatively, the subscriber may choose to forward the call to, for example, another employee or a system which will take custom actions, such as generating an audio message in response to the incoming call or playing a pre-recorded message.

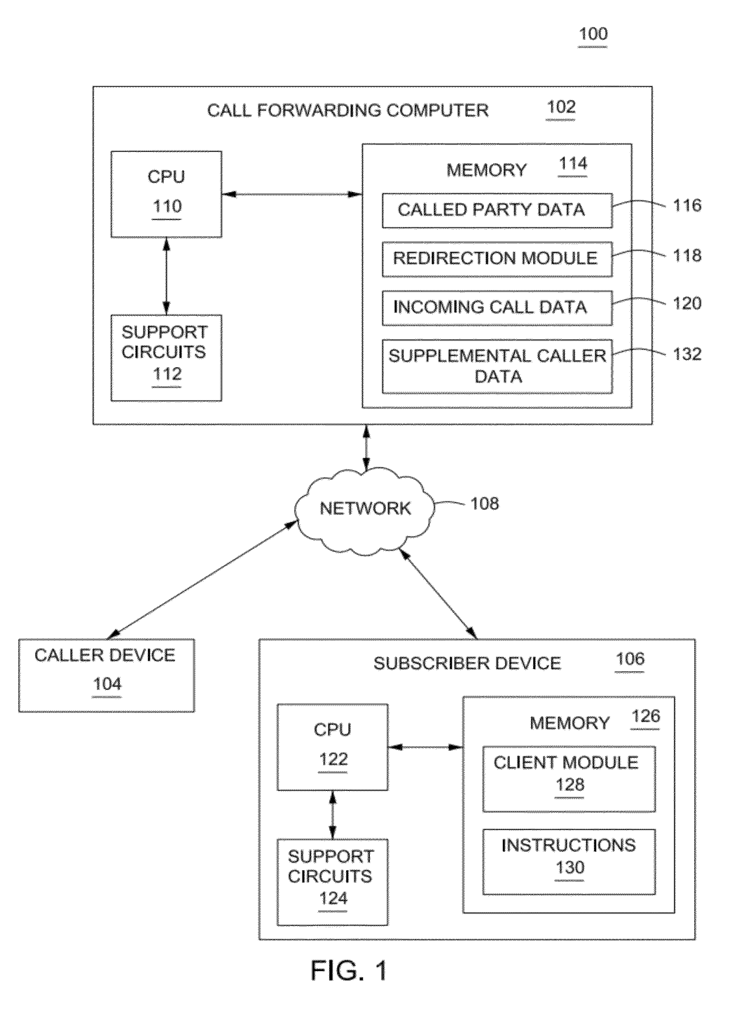

FIG. 1 is a structural block diagram of a call forwarding system 100 for providing called party data 116 to a subscriber via at least one mobile network according to one or more embodiments. The call forwarding system 100 includes a call forwarding computer 102, a caller device 104 and a subscriber device 106 such that each is coupled to each other through a mobile network 108.

The call forwarding computer 102 is a type of computerized device (e.g., a laptop, a desktop, a Personal Desk Assistant (PDA), a tablet, a mobile phone and the like) that comprises a central processing unit (CPU) 110, various support circuits 112 and a memory 114. The call forwarding computer 102 also includes interfaces for connecting incoming calls. The CPU 110 may comprise one or more commercially available microprocessors or microcontrollers that facilitate data processing and storage. Various support circuits 112 facilitate operation of the CPU 110 and may include clock circuits, buses, power supplies, input/output circuits and/or the like. The memory 114 includes a read only memory, random access memory, disk drive storage, optical storage, removable storage, and the like. The memory 114 includes various data, such as the called party data 116, incoming call data 120, and supplemental caller data 132. Called party data 116 may contain a toll-free customer service number for a commercial business along with a menu selection made by the caller, such as a selection for the billing department. Called party data 116 may also include additional information, such as a transaction identifier or customer code. Incoming call data 120 may contain the phone number of the caller device 104 and other information associated with that phone number such as a business name or caller name. Supplemental caller data 132 may contain notes on previous interactions with the caller, a transaction history of the caller, including a number of times the caller has called, a date of a last contact with the caller, and the like. The memory 114 includes various software packages, such as a redirection module 118.

While the caller device 104 may be any type of telecommunications device, the subscriber device 106 is a type of mobile device (e.g., a mobile or smart phone, a Personal Digital Assistant (PDA) and/or the like). Similar to other computerized devices, the subscriber device 106 includes a CPU 122, various support circuits 124, and a memory 126. The memory 126 includes various data and software, such as a client module 128 and instructions 130.

The network 108 comprises a communication system that connects devices by wire, cable, fiber optic, and/or wireless links facilitated by various types of well-known network elements, such as hubs, switches, routers, and the like. The network 108 may employ various well-known protocols to communicate information amongst the network resources. For example, the mobile network 108 may be part of the Internet or intranet using various communications infrastructure such as Ethernet, WiFi, WiMax, LTE, CDMA EVDO, 1xrtt, General Packet Radio Service (GPRS), Circuit Switched Data (CSD), and the like. As shown further below, the network 108 transmits voice and data via a voice network and a data network, respectively.

A subscriber to the call forwarding system 100 may use the subscriber device 106 as a single line smart phone with a single number. In addition, the subscriber may also use other phone numbers associated with one or more commercial businesses. Some of these phone numbers may be local numbers, toll-free numbers and/or the like. In some embodiments, incoming calls to these phone numbers may be forwarded to the subscriber device 106 by the call forwarding computer 102. Specifically, the redirection module 118 may implement various automated answering services (e.g., an auto-attendant) to allow the caller to navigate various menu options (e.g., services) provided by the called party. For example, certain employees of the called party may be pre-assigned to answer questions related to sales or billing while other employees have been trained to provide technical support. The caller must select certain digits of the menu options to arrive at an appropriate employee. In some embodiments, the call forwarding computer 102 may forward all incoming calls to the subscriber device 106 irrespective of any particular menu selection, thereby giving the caller the impression that the called organization is much bigger than it may actually be. When the incoming call arrives, the subscriber has enough information to provide efficient service consistent with the premise of having different menu selections directed to different departments as well as information noted during previous calls with the caller. As explained further below, the called party data 116 indicates the menu selection that was made by the calling party. This enables the subscriber to take a desired disposition action for the call.

More specifically, in some embodiments, the subscriber device 106 displays calling party data as well as the called party data 116 and supplemental caller data 132. In addition to the calling number (i.e., called ID), the subscriber device 106 displays information that may be stored locally (e.g., caller name, picture, location and/or the like). Such information may be displayed for subscriber assessment while the subscriber device 106 is ringing. For example, as soon as the subscriber device 106 starts ringing due to an incoming call from the caller device 104, the subscriber device 106 displays the caller name, a toll-free customer service number for a commercial business along with a menu selection made by the caller, such as a selection for the billing department. Optionally, the subscriber device 106 may include additional information, such as a transaction identifier, prior history, or customer code. This information may be stored locally on the subscriber device 106 or sent by the call forwarding computer 102 via the data channel to the subscriber device 106.

In some embodiments, the redirection module 118 uses a separate data channel, such as a mobile data network as explained further below, to send the called party data 116 to the subscriber device 106. On the other hand, the called party data 116 is communicated to the subscriber device 106 via another mobile network, such as a mobile voice network along with the incoming call using traditional calling party identification mechanisms associated with those networks.

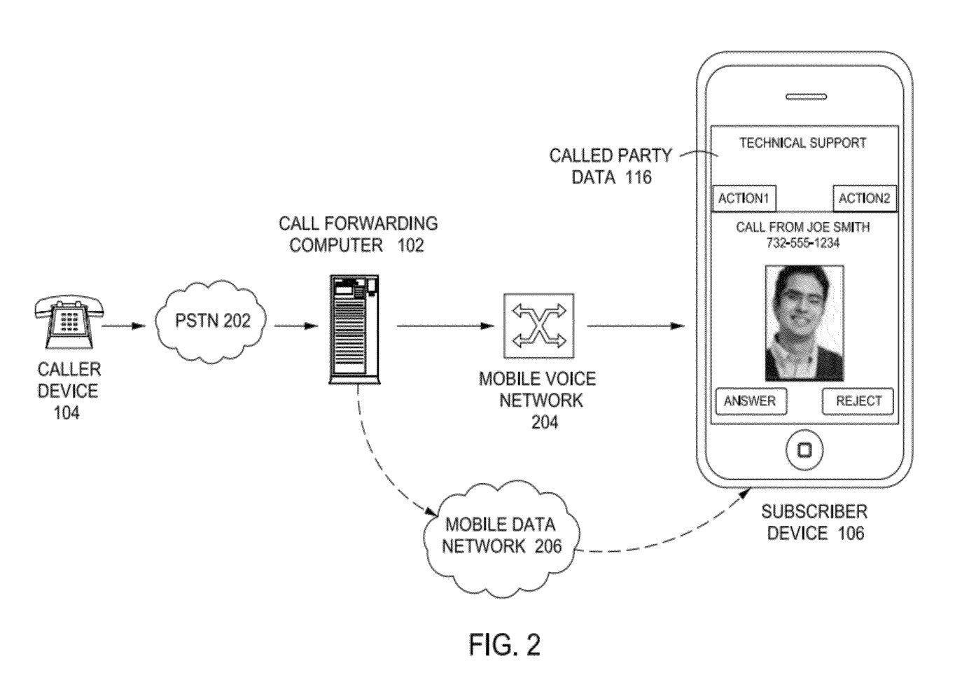

FIG. 2 is a functional block diagram illustrating a process for providing called party data to a subscriber of a call forwarding system via a mobile data network according to one or more embodiments. As depicted, the caller device 104 is used to make calls through a public switched telephone network (PTSN) 202.

For incoming calls to a commercial business, the call forwarding computer 102 uses a mobile voice network 204 to communicate voice data and a mobile data network 206 to communicate the called party data 116, the incoming call data 120, and the supplemental caller data 132. The subscriber device 106 subsequently displays the incoming call data 120, such as a calling number, the supplemental caller data 132, and, if the caller's number is stored in the memory of the subscriber device 106, the calling party name, in addition to the called party data 116, such as a commercial business name and number. As illustrated, the subscriber device 106 may also display as part of the called party data 116, menu selections made on an automated answering service, such as a selection made for technical support. In some embodiments, the called party data 116 is displayed while the subscriber device 106 is alerting (i.e., ringing or vibrating) the subscriber.

According to some embodiments, the subscriber device 106 may also display calling party data that is retrieved from an address book, such as calling party name or photograph. The subscriber may select standard actions, such as answering, rejecting or ignoring the incoming call. In some embodiments, the subscriber 106 performs custom actions, such as forwarding the incoming call to another device (e.g., another mobile phone of another employee), playing a pre-recorded message, sending the caller to a voice mail answering system to collect a message, respond via a message (e.g., text message, multimedia message, email message, instant message and/or the like) from the commercial business number and/or the like. According to some embodiments, these actions may be performed over a separate mobile data network. These actions may be implemented as a mobile application running locally on the device or presented on the subscriber device as a Hyper-Text Markup Language (HTML) browser window.

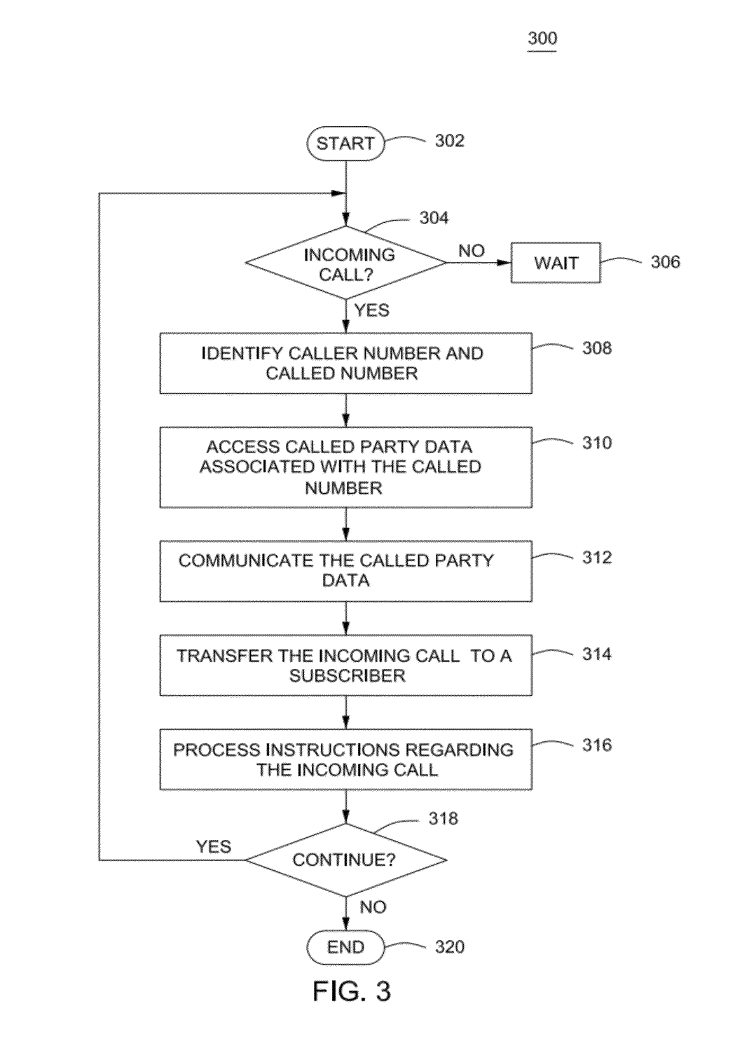

FIG. 3 is a flow diagram of a method 300 for providing called party data to a subscriber of a call forwarding system via at least one mobile network according to one or more embodiments. In some embodiments, each and every step of the method 300 is performed by a redirection module (e.g., the redirection module 118 of FIG. 1). In other embodiments, one or more steps are skipped or omitted. The method 300 starts at step 302 and proceeds to step 304.

Prior to redirecting incoming calls, the method 300 stores a call forwarding number and subscribes to a call forwarding system (e.g., the call forwarding system 100 of FIG. 1). The call forwarding number is a number that is assigned to a mobile phone (e.g., the subscriber device 106 of FIG. 1) by a mobile network carrier. The method 300 also stores one or more numbers for one or more called parties (e.g., one or more commercial businesses or one or more selectable departments of a business). Accordingly, the mobile phone will receive incoming calls intended for these numbers and/or selections, along with information about the originally called number.

At step 304, the method 300 determines whether there is an incoming call to the call forwarding number. If there is no incoming call, the method 300 proceeds to step 306 and waits. If there is an incoming call, the method 300 proceeds to step 308. At step 308, the method 300 identifies a caller number and a called number from the incoming call data. The method 300 proceeds to step 310. At step 310, the method 300 accesses called party data (e.g., the called party data 116 of FIG. 1) associated with the called number as well as any stored data associated with the calling party (e.g., the supplemental caller data 132 of FIG. 1). The method 300 proceeds to step 312. At step 312, the method 300 communicates the called party data to the mobile phone (e.g., the subscriber device 106 of FIG. 1) via a mobile data network (e.g., the mobile data network 206 of FIG. 2 or the mobile network 108 of FIG. 1). As part of the called party data, the method 300 may display the called number. The method 300 may also communicate the supplemental caller data to the mobile device via the mobile data network. The method 300 proceeds to step 314. At step 314, the method 300 transfers the incoming call to a subscriber. The method 300 originates a new call to the mobile phone via a mobile voice network (e.g., the mobile voice network 204 of FIG. 2) while maintaining a call with the original caller into the system. The method 300 proceeds to step 316.

At step 316, the method 300 processes instructions (e.g., the instructions 130 of FIG. 1) regarding the incoming call from the subscriber via the mobile phone. As explained in the present disclosure, the method 300 may answer, reject, forward the incoming call to another communication device or respond to the caller via a text message, among various other call disposition actions. The method 300 proceeds to step 318. At step 318, the method 300 determines whether to continue forwarding calls for the subscriber. If the subscriber decides to continue receiving calls, the method 300 returns to step 304. If, on the other hand, the subscriber decides to discontinue call forwarding, the method 300 proceeds to step 318 and ends.

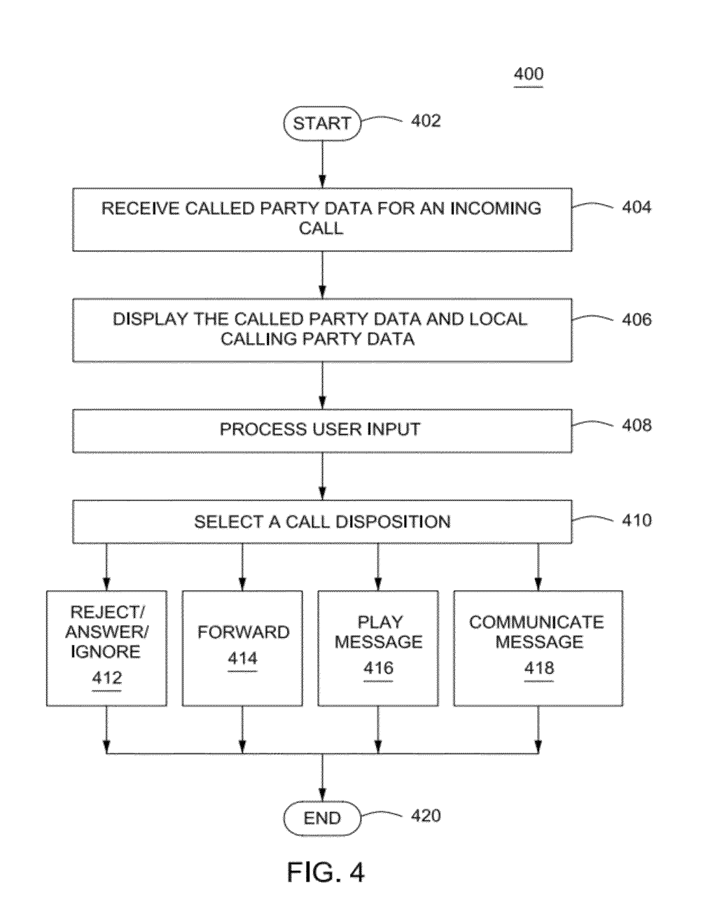

FIG. 4 is a flow diagram of a method 400 for handling an incoming call via at least one mobile network for a subscriber of a call forwarding system according to one or more embodiments. In some embodiments, each and every step of the method 400 is performed by client software (e.g., the client module 128 of FIG. 1) executing on a mobile device (e.g., the subscriber device 106 of FIG. 1). In other embodiments, one or more steps of method 400 are performed by the mobile device while one or more steps are performed by the Call Forwarding system. The method 400 starts at step 402 and proceeds to step 404.

At step 404, the method 400 receives called party data 116 for an incoming call. The method 400 proceeds to step 406. At step 406, the method 400 displays the called party data 116 and local calling party data. Local calling party data may be stored in memory on the subscriber's mobile device (e.g., the memory 126 of FIG. 1). Local calling party data contains information about a calling party, such as the calling party's picture, name, business name, and the like. The method 400 may also display supplemental caller data 132. The method 400 proceeds to step 408. At step 408, the method 400 processes user input. User input may be received from a touch screen on a mobile device or from button selection on a keypad of the mobile device. The method 400 proceeds to step 410. At step 410, the method 400 selects a call disposition action based on the user input. It is appreciated that although FIG. 4 illustrates six potential actions, other embodiments of the present disclosure envision additional possible call disposition actions.

In one embodiment, the method 400 selects a standard call disposition action and proceeds to step 412. At step 412, the method 400 rejects, answers or ignores the incoming call. In another embodiment, the method 400 selects another call disposition action and proceeds to step 414. At step 414, the method 400 forwards the incoming call to another device (e.g., a landline phone or another mobile phone, or a messaging system). In yet another embodiment, the method 400 selects a different call disposition action and proceeds to step 416. At step 416, the method 400 plays a pre-recorded message. Alternatively, the method 400 selects a call disposition action that involves responding to the caller and proceeds to step 418. At step 418, the method 400 communicates a message (e.g., an audio message) to the caller through the called party number. The method 400 proceeds to step 420. At step 420, the method 400 ends.

The foregoing description of embodiments of the invention comprises a number of elements, devices, circuits and/or assemblies that perform various functions as described. These elements, devices, circuits, and/or assemblies are merely exemplary implementations of means for performing their respectively described functions, and other implementations are possible. For example, although subscriber device 106 is illustrated to be a mobile device, it may be implemented as VoIP at a desktop or laptop computer.

While the foregoing is directed to embodiments of the present invention, other and further embodiments of the invention may be devised without departing from the basic scope thereof, and the scope thereof is determined by the claims that follow.

1. A computer-implemented method for providing called party data to a subscriber of a call forwarding system via at least one mobile network, comprising:
processing an incoming call to a subscriber device of a call forwarding system;
identifying a calling number and a called number of the incoming call, wherein the called number corresponds with a call forwarding number of the subscriber device;
accessing called party data that is associated with the called number; and
communicating the called party data to the subscriber device.

2. The method of claim 1, further comprising transferring the incoming call to the subscriber device.

3. The method of claim 2, wherein transferring the incoming call further comprises communicating the calling number to the subscriber device via a mobile voice network.

4. The method of claim 1, wherein communicating the called party data further comprises communicating the called party data via a mobile data network.

5. The method of claim 1, wherein the called party data comprises at least one automated menu selection by a caller.

6. The method of claim 1, wherein the called party data comprises the called number.

7. The method of claim 1 further comprising processing instructions from the subscriber device, wherein the instructions comprise at least one of forwarding the incoming call to another device, generating an audio message in response to the incoming call or playing a pre-recorded message.

8. An apparatus for providing called party data to a subscriber of a call forwarding system via at least one mobile network, comprising:
a call forwarding computer, comprising:
a redirection module for processing an incoming call to a subscriber device of a call forwarding system, identifying a calling number and a called number of the incoming call, wherein the called number corresponds with a call forwarding number of the subscriber device, accessing called party data that is associated with the called number, and communicating the called party data to the subscriber device.

9. The apparatus of claim 8, further comprising transferring the incoming call to the subscriber device.

10. The apparatus of claim 8, wherein the redirection module communicates the calling number to the subscriber device via a mobile voice network.

11. The apparatus of claim 8, wherein the redirection module communicates the called party data via a mobile data network.

12. The apparatus of claim 8, wherein the called party data comprises at least one automated menu selection by a caller.

13. The apparatus of claim 8, wherein the called party data comprises the called number.

14. The apparatus of claim 8, wherein the redirection module processes instructions from the subscriber device.

15. The apparatus of claim 8, wherein the redirection module performs, on behalf of the subscriber device, at least one of rejecting the incoming call, answering the incoming call, ignoring the incoming call, forwarding the incoming call to another device, generating a text message in response to the incoming call or playing a pre-recorded message.

16. A computer implemented method for processing an incoming call to a subscriber of a call forwarding system via at least one mobile network comprising:
receiving called party data for an incoming call;
displaying the called party data and local called party data on a subscriber device;
processing input on the subscriber device, the input based on the called party data; and
selecting a call disposition based on the input to the subscriber device.

17. The method of claim 16, wherein the called party data comprises at least one automated menu selection by a caller.

18. The method of claim 16, wherein selecting a call disposition comprises at least one of rejecting the incoming call, answering the incoming call, ignoring the incoming call, forwarding the incoming call to another device, generating an audio message in response to the incoming call or playing a pre-recorded message.

19. A system for providing called party data to a subscriber device using a call forwarding system via at least one mobile network comprising:
a caller device for placing an incoming call to the subscriber of a call forwarding system;
a call forwarding system for identifying a calling number and a called number of the incoming call, wherein the called number corresponds with a call forwarding number of the subscriber device, accessing called party data that is associated with the called number, and communicating the called party data to the subscriber device, wherein the subscriber device receives called party data and selects a call disposition based on the received called party data; and
at least one mobile network for transmitting at least one of voice or data to the subscriber device.

20. The system of claim 19, wherein selecting a call disposition comprises at least one of rejecting the incoming call, answering the incoming call, ignoring the incoming call, forwarding the incoming call to another device, generating an audio message in response to the incoming call or playing a pre-recorded message.
